(19) United States
(12) Patent Application Publication
(10) Pub. No.: US 2026/0163748 A1
(43) Pub. Date: Jun. 11, 2026

(54) COMMUNICATION CONTROL SYSTEM, COMMUNICATION CONTROL METHOD, AND TERMINAL APPARATUS

(71) Applicant: NEC Corporation, Tokyo (JP)

(72) Inventors: Kazuaki NAKAJIMA, Tokyo (JP); Yusuke YAMAZAKI, Tokyo (JP); Takanari ARAI, Tokyo (JP); Kei KITAMURA, Tokyo (JP)

(73) Assignee: NEC Corporation, Tokyo (JP)

(21) Appl. No.: 19/400,120

(22) Filed: Nov. 25, 2025

(30) Foreign Application Priority Data
Dec. 11, 2024 (JP) 2024-216253

(51) Int. Cl. H04L 9/32; H04L 9/40

(52) U.S. Cl. CPC H04L 9/3263; H04L 63/0823

(57) ABSTRACT

A communication control system according to the present disclosure includes, a terminal apparatus including, at least one memory storing instructions and at least one processor configured to execute the instructions to replace, in a case where a predetermined digital certificate has been issued at time of communication by an application of the terminal apparatus and authenticity of a communication infrastructure of the terminal apparatus has been confirmed, the digital certificate with an authenticity certificate certifying the authenticity, and transmit the authenticity certificate to a predetermined server, and a verification apparatus including, at least one memory storing instructions and at least one processor configured to execute the instructions to receive the authenticity certificate from the terminal apparatus, and verify the authenticity certificate to determine whether to permit the communication by the application to the server.

### INCORPORATION BY REFERENCE

This application is based upon and claims the benefit of priority from Japanese patent application No. 2024-216253, filed on December 11, 2024, the disclosure of which is incorporated herein in its entirety by reference.

### TECHNICAL FIELD

The present disclosure relates to a communication control system, a communication control method, and a terminal apparatus.

### BACKGROUND ART

In recent years, a technology has been disclosed related to communication control of a terminal apparatus based on authentication of a digital certificate. For example, JP 2022-123850 A discloses a technology in which a proxy including an approval module authenticates a digital certificate at time of communication of a user device, so that the user device implements communication for a data network or a resource coupled to the data network. JP 2022-123850 A also discloses a technology that includes a second proxy configured for communication with a resource and controls communication through a communication channel between a data network and the resource by the second proxy authenticating a digital certificate. The digital certificate in JP 2022-123850 A refers to a certificate issued based on a Public Key Infrastructure (PKI).

### SUMMARY

However, in the verification method using a digital certificate according to JP 2022-123850 A, zero trust security cannot be implemented. Unlike perimeter security, zero trust security is an approach for verifying authenticity of access from any device or application, including resources present in an internal network. Here, authenticity is also referred to as non-falsification. The digital certificate used for verification in the technology according to JP 2022-123850 A is a certificate issued based on PKI. For that reason, with the digital certificate according to JP 2022-123850 A, it is not possible to verify authenticity of a communication infrastructure in a target terminal. Accordingly, with the technology according to JP 2022-123850 A, it is not possible to perform application communication on a communication infrastructure whose authenticity is verified.

The present disclosure has been made to solve such a problem, and an example object thereof is to provide a communication control system, a communication control method, and a terminal apparatus capable of performing application communication on a communication infrastructure whose authenticity is verified.

A communication control system according to an example aspect of the present disclosure includes, a terminal apparatus including at least one memory storing instructions and at least one processor configured to execute the instructions to replace, in a case where a predetermined digital certificate has been issued at time of communication by an application of the terminal apparatus and authenticity of a communication infrastructure of the terminal apparatus has been confirmed, the digital certificate with an authenticity certificate certifying the authenticity, and transmit the authenticity certificate to a predetermined server, and a verification apparatus including at least one memory storing instructions and at least one processor configured to execute the instructions to receive the authenticity certificate from the terminal apparatus, and verify the authenticity certificate to determine whether to permit the communication by the application to the server.

In a communication control method according to an example aspect of the present disclosure, one or more computers replace, in a case where a predetermined digital certificate has been issued at time of communication by an application of the terminal apparatus and authenticity of a communication infrastructure of the terminal apparatus has been confirmed, the digital certificate with an authenticity certificate certifying the authenticity, transmit the authenticity certificate to a predetermined server, receive the authenticity certificate from the terminal apparatus, verify the authenticity certificate, and determine whether to permit the communication by the application to the server.

A terminal apparatus according to an example aspect of the present disclosure includes, at least one memory storing instructions and at least one processor configured to execute the instructions to replace, in a case where a predetermined digital certificate has been issued at time of communication by an application of the terminal apparatus and authenticity of a communication infrastructure of the terminal apparatus has been confirmed, the digital certificate with an authenticity certificate certifying the authenticity, and transmit the authenticity certificate to a predetermined server.

According to the present disclosure, it is possible to provide a communication control system, a communication control method, and a terminal apparatus capable of performing application communication on a communication infrastructure whose authenticity is verified.

### BRIEF DESCRIPTION OF DRAWINGS

The above and other aspects, features, and advantages of the present disclosure will become more apparent from the following description of certain example embodiments in a case where taken in conjunction with the accompanying drawings, in which:

FIG. 1 is a block diagram illustrating a configuration of a communication control system according to the present disclosure;

FIG. 2 is a flowchart illustrating an example of a processing operation of the communication control system;

FIG. 3 is a block diagram illustrating a configuration of a communication control system according to the present disclosure;

FIG. 4 is a schematic diagram illustrating a specific example of the communication control system;

FIG. 5 is a sequence diagram illustrating an example of a processing operation of the communication control system; and

FIG. 6 is a diagram illustrating a hardware configuration example of a communication control system according to the present disclosure.

### EXAMPLE EMBODIMENT

### First Example Embodiment

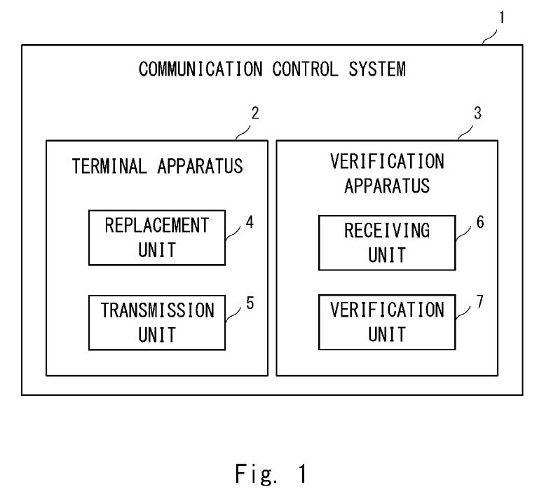

A first example embodiment according to the present disclosure will be described below with reference to the drawings. FIG. 1 is a block diagram illustrating a configuration of a communication control system 1 according to the present disclosure. The communication control system 1 includes a terminal apparatus 2 and a verification apparatus 3. It is assumed that PKI is constructed in an environment of the communication control system 1.

The terminal apparatus 2 is a communication apparatus that stores one or a plurality of applications. The terminal apparatus 2 can perform data communication with a server or another terminal apparatus. That is, the terminal apparatus 2 includes a communication infrastructure for performing data communication with a server or another terminal apparatus. For example, the terminal apparatus 2 can perform data communication with the verification apparatus 3. The terminal apparatus 2 can perform data communication by an Internet line. That is, the terminal apparatus 2 performs data communication via a network to which a third party can be connected. Here, the terminal apparatus 2 may be capable of performing data communication by a closed network together with communication by an Internet line. The terminal apparatus 2 may be capable of data communication either wirelessly or via a wire. For example, the terminal apparatus 2 may be capable of data communication by satellite communication, optical communication, or mobile communication. The terminal apparatus 2 is, for example, a communication apparatus mounted on a mobile body. Here, the mobile body may be an aircraft, a vehicle, or a ship.

An application stored in the terminal apparatus 2 encrypts data at the time of performing communication with a predetermined server. The application of the terminal apparatus 2 may encrypt data by a common key encryption method, may encrypt data by a public key encryption method, or may encrypt data by a hybrid encryption method. The hybrid encryption method is an encryption method that is a combination of the common key encryption method and the public key encryption method. Hereinafter, the description will be continued assuming that an application program of the terminal apparatus 2 encrypts data by the public key encryption method.

During encryption of data, the application of the terminal apparatus 2 requests a server of a Certificate Authority (CA) to issue a digital certificate. The digital certificate is also referred to as a public key certificate in the PKI. The CA from which the application of the terminal apparatus 2 requests issuance of the digital certificate may be a root CA, an intermediate CA, or a private CA. The CA confirms and examines a Certificate Signing Request (CSR) from the application. The CA then issues a digital certificate and signs the digital certificate with the CA's secret key. The application of the terminal apparatus 2 transmits the digital certificate received from the server of the CA to a predetermined server. In other words, the application of the terminal apparatus 2 presents the digital certificate to a predetermined server. The digital certificate issued by the CA may be the CSR to which a signature of the CA is attached. The signature of the CA may be obtained by encryption of a hash value of the CSR with the secret key of the CA. Here, the hash value refers to a character string generated by a hash function.

The digital certificate according to the first example embodiment is, for example, a Secure Sockets Layer (SSL) certificate. The SSL certificate is also referred to as an SSL/Transport Layer Security (TLS) certificate. That is, the application of the terminal apparatus 2 may encrypt data according to an SSL/TLS security protocol.

The application of the terminal apparatus 2 may perform data communication according to Transmission Control Protocol (TCP) communication protocol. The application of the terminal apparatus 2 may perform data communication according to a User Datagram Protocol (UDP) communication protocol. That is, the application of the terminal apparatus 2 may use a Datagram Transport Layer Security (DTLS) security protocol.

The digital certificate according to the first example embodiment may be created according to the X.509 protocol. The digital certificate may include information on the CA, information on the terminal apparatus 2, a public key, and a signature by the CA.

The terminal apparatus 2 includes a replacement unit 4 and a transmission unit 5. The terminal apparatus 2 includes a control unit (not illustrated) that executes the application. The control unit can be implemented by, for example, an integrated circuit, and executes the application by a Central Processing Unit (CPU), a Micro Processing Unit (MPU), or the like.

The replacement unit 4 has a function of replacing, in a case where a predetermined digital certificate is issued at the time of communication by the application of the terminal apparatus 2 and authenticity of a communication infrastructure in the terminal apparatus 2 has been confirmed, the digital certificate with an authenticity certificate certifying the authenticity.

Here, the authenticity and the authenticity certificate will be described. The authenticity is also referred to as non-falsification. That is, confirming the authenticity of the communication infrastructure in the terminal apparatus 2 means confirming that a hardware configuration and software of the communication infrastructure in the terminal apparatus 2 are normal, or one of them is normal. Here, the hardware configuration may include a CPU, a memory, or a Hard Disk Drive (HDD). The software may include an application, an Operating System (OS), a boot loader, or a Basic Input/Output System (BIOS).

The authenticity of the communication infrastructure in the terminal apparatus 2 is confirmed based on data stored in a Trusted Platform Module (TPM) embedded in the communication infrastructure of the terminal apparatus 2. The authenticity of the communication infrastructure in the terminal apparatus 2 may be confirmed by another server or may be confirmed by the terminal apparatus 2. The TPM may have a function of generating a secret key and a public key, a function of digitally signing, and a function of calculating a hash value.

The authenticity certificate is a certificate issued in a case where the authenticity of the communication infrastructure in the terminal apparatus 2 has been confirmed. That is, the authenticity certificate includes information indicating that the authenticity of the communication infrastructure in the terminal apparatus 2 has been confirmed. The authenticity certificate may be created according to the same security protocol as that for the digital certificate issued at the time of communication by the application of the terminal apparatus 2. That is, the authenticity certificate may be created according to the X.509 protocol. The authenticity certificate may include the same content as that of the digital certificate. That is, the authenticity certificate may include information on an issuer of the authenticity certificate, information on the terminal apparatus 2, a signature by the issuer of the authenticity certificate, and a public key for verifying the signature.

The authenticity certificate may be issued by the terminal apparatus 2 or may be issued by another server. In a case where another server has confirmed the authenticity of the communication infrastructure in the terminal apparatus 2 and the terminal apparatus 2 issues the authenticity certificate, the another server may transmit a confirmation result of the authenticity to the terminal apparatus 2. In a case where the terminal apparatus 2 has confirmed the authenticity and another server issues the authenticity certificate, the terminal apparatus 2 may transmit a confirmation result of the authenticity to the another server.

The authenticity certificate is signed by an issuer of the certificate. In a case where the terminal apparatus 2 signs the authenticity certificate, the terminal apparatus 2 may sign by using a secret key generated by the TPM or may sign by using another secret key. In this case, the terminal apparatus 2 may transmit a public key associated to the secret key to another server to which the authenticity certificate is transmitted.

The description returns to the description of the replacement unit 4. In a case where the authenticity of the communication infrastructure in the terminal apparatus 2 has been confirmed, the replacement unit 4 replaces the digital certificate with the authenticity certificate. In other words, in a case where the authenticity of the terminal apparatus 2 is not confirmed, the authenticity certificate is not issued, and thus the replacement unit 4 does not replace the digital certificate with the authenticity certificate.

In a case where the authenticity of the communication infrastructure in the terminal apparatus 2 has been confirmed, the replacement unit 4 may necessarily replace the digital certificate with the authenticity certificate, or may not. That is, even in a case where the authenticity of the communication infrastructure in the terminal apparatus 2 has been confirmed, the replacement unit 4 may not replace the digital certificate with the authenticity certificate. For example, in a case where an application communication destination of the terminal apparatus 2 is a server determined in advance, the replacement unit 4 may perform the replacement. Here, the “server determined in advance” is also expressed as a “server registered in advance in the terminal apparatus 2”. For example, in a case where the communication destination is a server to which relay is performed by the verification apparatus 3 and the server is a server determined in advance, the replacement unit 4 may perform the replacement.

The replacement unit 4 may decrypt the signature attached to the digital certificate with the public key of the CA, rewrite the digital certificate to the content of the authenticity certificate, and newly attach a predetermined signature to replace the digital certificate with the authenticity certificate. The replacement unit 4 may delete the digital certificate and the signature by the CA, and perform the replacement by using the authenticity certificate and the predetermined signature as new transmission data.

The replacement unit 4 transmits the authenticity certificate to the transmission unit 5. Here, in a case where the replacement unit 4 has not replaced the digital certificate with the authenticity certificate, the replacement unit 4 may transmit the digital certificate to the transmission unit 5.

The transmission unit 5 has a function of transmitting the authenticity certificate to a predetermined server. In other words, the transmission unit 5 has a function of presenting the authenticity certificate to a predetermined server. In a case where the server is a server to which relay is performed by the verification apparatus 3, the transmission unit 5 can transmit the authenticity certificate to the verification apparatus 3.

The transmission unit 5 can transmit the authenticity certificate to a predetermined server in a case where the authenticity of the communication infrastructure has been confirmed, and can transmit the digital certificate to the server in a case where the authenticity of the communication infrastructure is not confirmed. For example, in a case where the authenticity of the communication infrastructure in the terminal apparatus 2 has been confirmed and the communication destination is a server determined in advance, the replacement unit 4 replaces the digital certificate with the authenticity certificate. In this case, the transmission unit 5 transmits the authenticity certificate to a predetermined server. On the other hand, in a case where the authenticity of the communication infrastructure in the terminal apparatus 2 is not confirmed, the replacement unit 4 does not replace the digital certificate with the authenticity certificate. In this case, the transmission unit 5 may or may not transmit, to the server, the digital certificate not replaced. That is, in a case where the digital certificate is not replaced with the authenticity certificate, the transmission unit 5 may or may not permit the communication by the application of the terminal apparatus 2.

Next, the verification apparatus 3 will be described. The verification apparatus 3 is a communication apparatus that verifies whether to permit communication to a predetermined server that is a target with which the application of the terminal apparatus 2 performs communication. The verification apparatus 3 includes a receiving unit 6 and a verification unit 7. The verification apparatus 3 is typically a proxy server, but may not be a proxy server as long as it has functions of the receiving unit 6 and the verification unit 7 described below. That is, the verification apparatus 3 may relay communication to a predetermined server that is a target with which the application of the terminal apparatus 2 performs communication.

The receiving unit 6 has a function of receiving the authenticity certificate. The receiving unit 6 may have a function of receiving the digital certificate. The receiving unit 6 may have a function of receiving a verification key for verifying the signature attached to the authenticity certificate. The receiving unit 6 transmits the authenticity certificate or the digital certificate to the verification unit 7.

The verification unit 7 has a function of receiving the authenticity certificate from the receiving unit 6 and verifying the authenticity certificate to determine whether to permit the communication by the application of the terminal apparatus 2 to a target server. Here, the verification unit 7 may receive the digital certificate from the receiving unit 6. In this case, the verification unit 7 may verify the digital certificate.

The verification unit 7 can verify whether the authenticity certificate is a valid authenticity certificate. For example, the verification unit 7 can verify whether the authenticity certificate received by the receiving unit 6 is the authenticity certificate transmitted by the transmission unit 5. As an example, first, the verification unit 7 obtains a hash value by decrypting the signature attached to the authenticity certificate received by the receiving unit 6. The signature may be a signature by another server or a signature by the terminal apparatus 2. Here, in a case where the signature attached to the authenticity certificate is a signature by another server, the verification unit 7 is assumed to have received a verification key for decrypting the signature from the another server in advance. In a case where the signature attached to the authenticity certificate is a signature by the terminal apparatus 2, the verification unit 7 may have a verification key for decrypting the signature in advance, or may receive the verification key from the terminal apparatus 2 or another server. The verification key may be a public key issued by the TPM of the terminal apparatus 2.

Next, the verification unit 7 calculates a hash value of the authenticity certificate. Thereafter, the verification unit 7 compares the hash value obtained by decrypting the signature attached to the authenticity certificate with the hash value of the authenticity certificate itself. Here, the verification unit 7 obtains the hash value of the authenticity certificate itself by calculating a hash function. In a case where the two values are the same as each other, the verification unit 7 can confirm that the authenticity certificate received by the receiving unit 6 is the authenticity certificate transmitted by the transmission unit 5.

The verification unit 7 may be able to verify whether the certificate has confirmed the authenticity of the communication infrastructure in the terminal apparatus 2 by verifying the content of the authenticity certificate. In a case where it can be confirmed that a verification result of the authenticity certificate is correct, the verification unit 7 can permit the communication by the application of the terminal apparatus 2 to the target server.

The verification unit 7 may be able to verify whether the digital certificate is a valid digital certificate. That is, in a case where the receiving unit 6 receives a digital certificate, the verification unit 7 may be able to verify whether the digital certificate is a valid digital certificate related to the terminal apparatus 2. First, the verification unit 7 obtains a hash value by decrypting the signature attached to the digital certificate received by the receiving unit 6. This is performed with the public key of the CA that has put the signature. Next, the verification unit 7 calculates a hash value of the digital certificate. Thereafter, the verification unit 7 compares the hash value obtained by decrypting the signature attached to the digital certificate with the hash value of the digital certificate itself. In a case where the two values are the same as each other, the verification unit 7 can confirm that the digital certificate received by the receiving unit 6 is valid.

The verification unit 7 may permit the communication by the application of the terminal apparatus 2 only in a case where the verification result of the authenticity certificate is correct. That is, in a case where the receiving unit 6 receives the digital certificate, the verification unit 7 may not permit the communication by the application of the terminal apparatus 2 even if it can be confirmed that the digital certificate is valid. Conversely, in a case where it can be confirmed that the digital certificate is valid, the verification unit 7 may permit the communication by the application of the terminal apparatus 2.

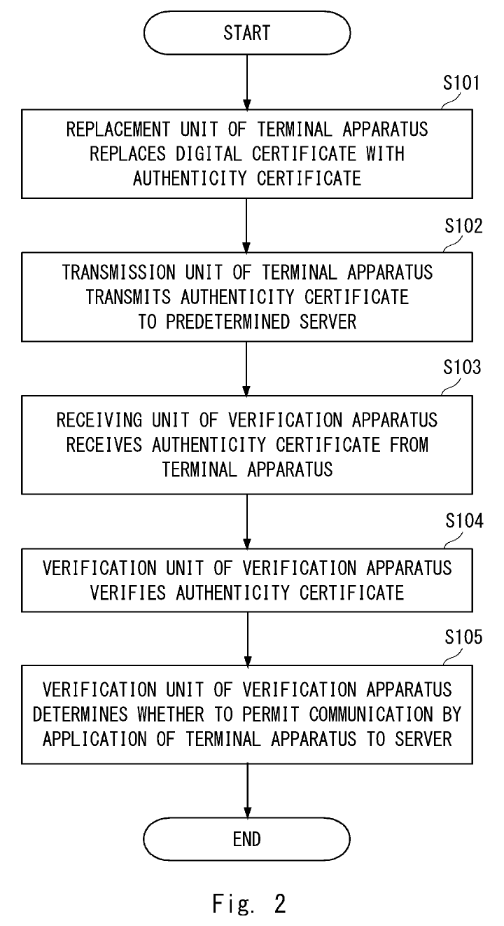

Next, a flow of a processing operation by the communication control system 1 will be described. FIG. 2 is a flowchart illustrating an example of the processing operation of the communication control system 1. First, the replacement unit 4 of the terminal apparatus 2 replaces a digital certificate issued at the time of communication by an application of the terminal apparatus 2 with an authenticity certificate (S101). Next, the transmission unit 5 of the terminal apparatus 2 transmits the authenticity certificate to a predetermined server (S102). Here, the predetermined server may be a server through which the communication is relayed by the verification apparatus 3. Next, the receiving unit 6 of the verification apparatus 3 receives the authenticity certificate from the terminal apparatus 2 (S103). Thereafter, the verification unit 7 of the verification apparatus 3 verifies the authenticity certificate (S104). Finally, the verification unit 7 of the verification apparatus 3 determines whether to permit the communication by the application to the server of the terminal apparatus 2 (S105). The communication control system 1 may execute the above flow every time the application of the terminal apparatus 2 performs communication.

As described above, the communication control system 1 according to the first example embodiment replaces the digital certificate issued at the time of application communication with the authenticity certificate and verifies the authenticity certificate, thereby enabling application communication on the communication infrastructure whose authenticity is verified. In the technology according to JP 2022-123850 A, since the digital certificate is a certificate issued based on PKI, such as an SSL/TLS certificate, or the like, the authenticity of the communication infrastructure in a user device cannot be verified. For that reason, in the technology according to JP 2022-123850 A, zero trust security cannot be implemented. This is because the digital certificate based on the PKI only performs authentication as a communication path, and authentication cannot be performed of the communication infrastructure of the terminal apparatus in which the application is stored.

In the communication control system 1 according to the first example embodiment, the terminal apparatus 2 replaces a digital certificate issued at the time of communication by an application with an authenticity certificate, and transmits the authenticity certificate to a target server. The verification apparatus 3 receives the authenticity certificate and verifies the authenticity certificate, thereby determining whether to permit the communication by the application of the terminal apparatus 2. As a result, since the authenticity of the communication infrastructure in the terminal apparatus can be confirmed, zero trust security can be implemented by the communication control system 1.

As a method of performing application communication on a communication infrastructure whose authenticity is verified, it is conceivable that, in a case where authenticity has been confirmed by some method, communication is started by use of a certificate for confirming the authenticity, and authentication cooperation is performed in an opposite server. In this case, it is necessary for the application side to perform authentication cooperation for the certificate. However, there is a case where it is difficult to implement authentication cooperation on the application side, such as a case where a manufacturer of the application is different from a manufacturer of the communication infrastructure. In such a case, it is difficult to implement zero trust security.

According to the communication control system 1, by replacing a digital certificate transmitted by an application with an authenticity certificate, it is possible to implement zero trust security without changing an application program.

In the communication control system 1, the verification apparatus 3 can permit the communication by the application of the terminal apparatus 2 only in a case where the verification result of the authenticity certificate is correct. In a case where the authenticity of the communication infrastructure in the terminal apparatus 2 cannot be confirmed, the terminal apparatus 2 does not perform the replacement with the authenticity certificate. For that reason, the verification apparatus 3 cannot verify the authenticity certificate. In such a case, the verification apparatus 3 does not permit the communication to the server, whereby the communication by the application based on more reliable zero trust security can be performed.

The communication control system 1 can transmit the authenticity certificate to the server in a case where the authenticity of the communication infrastructure in the terminal apparatus 2 has been confirmed, and can transmit the digital certificate to the server in a case where the authenticity is not confirmed. That is, in a case where the authenticity is not confirmed, by transmitting the digital certificate rather than not permitting any communication, it is possible to permit the communication by the application exceptionally even in a case where zero trust security is not implemented. This is effective, for example, in a case where the application program is corrected.

In the communication control system 1, in a case where the target server of the communication by the terminal apparatus 2 is a server determined in advance, the terminal apparatus 2 can replace the digital certificate with the authenticity certificate. As a result, with the authenticity certificate, the terminal apparatus 2 can suppress access to a server not determined in advance.

### Second Example Embodiment

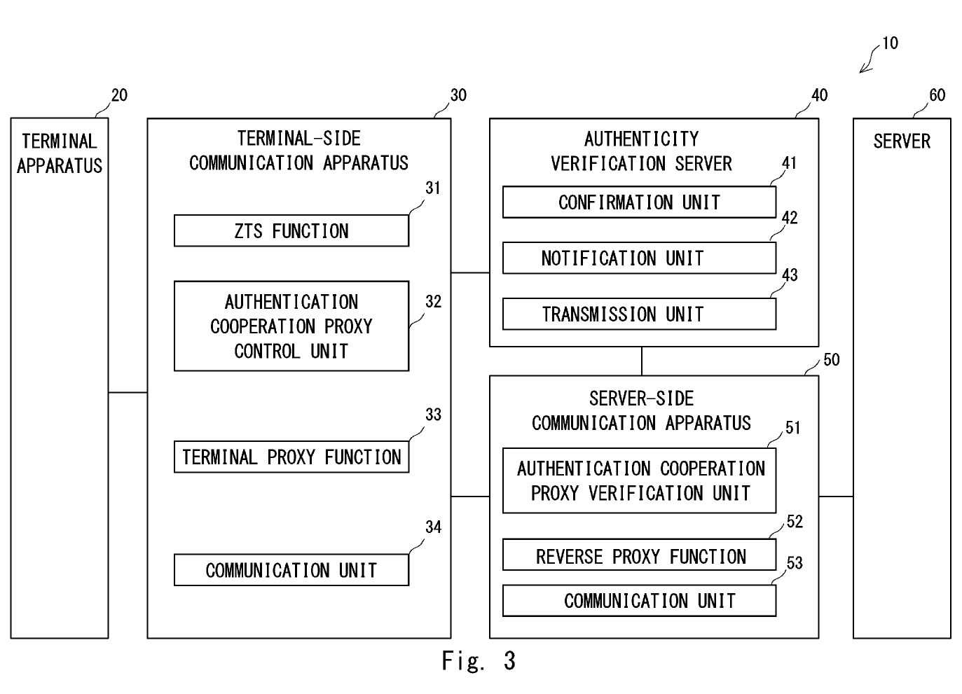

Next, a second example embodiment according to the present disclosure will be described with reference to the drawings. FIG. 3 is a block diagram illustrating a configuration of a communication control system 10 according to the present disclosure. The communication control system 10 includes a terminal apparatus 20, a terminal-side communication apparatus 30, an authenticity verification server 40, a server-side communication apparatus 50, and a server 60. The communication control system 10 has a configuration for specifically implementing the communication control system 1 according to the first example embodiment.

In the communication control system 10, it is assumed that the terminal apparatus 20 can perform data communication with the terminal-side communication apparatus 30. It is assumed that the terminal-side communication apparatus 30 can perform data communication with the terminal apparatus 20, the authenticity verification server 40, and the server-side communication apparatus 50. It is assumed that the authenticity verification server 40 can perform data communication with the terminal-side communication apparatus 30 and the server-side communication apparatus 50. It is assumed that the server-side communication apparatus 50 can perform data communication with the authenticity verification server 40 and the server 60.

Here, data communication is performed via an Internet line between the terminal-side communication apparatus 30 and the server-side communication apparatus 50. Data communication may be performed via an Internet line or a closed network between the terminal apparatus 20 and the terminal-side communication apparatus 30. The same applies between the terminal-side communication apparatus 30 and the authenticity verification server 40, between the server-side communication apparatus 50 and the server 60, and between the authenticity verification server 40 and the server-side communication apparatus 50. Each type of communication may be performed in a wireless or wired communication method. In each type of communication, data communication may be performed by, for example, satellite communication, optical communication, or mobile communication.

Data communication between the terminal-side communication apparatus 30 and the server-side communication apparatus 50 is performed based on a predetermined security protocol. The predetermined security protocol is, for example, SSL, TLS, or DTLS. Data communication between the terminal apparatus 20 and the terminal-side communication apparatus 30 may be performed based on the predetermined security protocol. The same applies to data communication between the terminal-side communication apparatus 30 and the authenticity verification server 40, between the authenticity verification server 40 and the server-side communication apparatus 50, and between the server-side communication apparatus 50 and the server 60.

In a case where data communication is performed between the terminal-side communication apparatus 30 and the authenticity verification server 40 or between the authenticity verification server 40 and the server-side communication apparatus 50, it is assumed that the authenticity of the communication infrastructure between these apparatuses is confirmed. That is, it is assumed that zero trust security is secured at the time of data communication between these apparatuses. In other words, data communication is performed between these apparatuses, based on a protocol that implements zero trust security.

For example, in a case where data communication is performed between the terminal-side communication apparatus 30 and the authenticity verification server 40, it is assumed that it is confirmed that the hardware configuration and software are normal in the terminal-side communication apparatus 30, the authenticity verification server 40, and a communication path between these apparatuses. Similarly, in a case where data communication is performed between the authenticity verification server 40 and the server-side communication apparatus 50, it is assumed that it is confirmed that the hardware configuration and software are normal in the authenticity verification server 40, the server-side communication apparatus 50, and a communication path between these apparatuses.

The terminal apparatus 20 is any apparatus that stores one or a plurality of applications. The terminal apparatus 20 includes a control unit (not illustrated) that executes the application. The terminal apparatus 20 is a terminal apparatus mounted on a mobile body. The mobile body may be an aircraft, a vehicle, or a ship.

The application stored in the terminal apparatus 20 performs encrypted data communication with the server 60 or another server in execution of the application. The encryption method is similar to that of the application of the terminal apparatus 2 according to the first example embodiment. During encryption of data, the application of the terminal apparatus 20 requests the server of the CA to issue a digital certificate. Here, the CA may be a root CA, an intermediate CA, or a private CA (not illustrated in FIG. 3), or may be the authenticity verification server 40. The digital certificate in this case is also referred to as a client certificate. Since details of the digital certificate issued at the time of data communication by the application of the terminal apparatus 20 are similar to those of the digital certificate related to the data communication by the application of the terminal apparatus 2 according to the first example embodiment, the description thereof will be omitted.

The data communication by the application of the terminal apparatus 20 is relayed by the terminal-side communication apparatus 30. That is, the application of the terminal apparatus 20 encrypts the data, for example, with the terminal-side communication apparatus 30 as the other party of the data communication. In this case, the terminal apparatus 20 transmits the digital certificate by the CA and a public key issued by the terminal apparatus 20 to the terminal-side communication apparatus 30. This public key is a verification key for verifying a signature attached to communication data by the application of the terminal apparatus 20. On the other hand, the communication data by the application of the terminal apparatus 20 may be encrypted by a public key generated by the terminal-side communication apparatus 30.

The terminal-side communication apparatus 30 is a communication infrastructure for transmitting application data of the terminal apparatus 20 to a predetermined server. The terminal-side communication apparatus 30 has a configuration similar to that of the communication infrastructure in the terminal apparatus 2 according to the first example embodiment. It is assumed that a TPM for confirming authenticity of the terminal-side communication apparatus 30 is embedded in the terminal-side communication apparatus 30. The terminal-side communication apparatus 30 is, for example, a communication apparatus mounted on a mobile body. The terminal-side communication apparatus 30 relays the data communication by the application of the terminal apparatus 20. That is, the terminal-side communication apparatus 30 may be a forward proxy. The terminal-side communication apparatus 30 includes a Zero Trust Security (ZTS) function 31, an authentication cooperation proxy control unit 32, a terminal proxy function 33, and a communication unit 34.

The ZTS function 31 is a function of grasping the authenticity of the terminal-side communication apparatus 30 at the time of the data communication by the terminal apparatus 20. The ZTS function 31 may or may not grasp the authenticity of the terminal-side communication apparatus 30 every time the data communication is performed by the terminal apparatus 20. At the time of confirmation of the authenticity of the terminal-side communication apparatus 30, the ZTS function 31 can transmit a confirmation request for the authenticity of the terminal-side communication apparatus 30 to the authenticity verification server 40. The ZTS function 31 can receive a confirmation result regarding the authenticity of the terminal-side communication apparatus 30 from the authenticity verification server 40 via the communication unit 34.

In a case where the ZTS function 31 receives information indicating that the authenticity of the terminal-side communication apparatus 30 has been confirmed from the authenticity verification server 40 via the communication unit 34, the ZTS function 31 can issue an authenticity certificate. The authenticity certificate may include information on the terminal-side communication apparatus 30, a signature by the ZTS function 31, and a public key for verifying the signature. The ZTS function 31 may sign the authenticity certificate by use of a secret key issued by the TPM, or by use of any other secret key. Other features of the authenticity certificate are similar to those of the authenticity certificate according to the first example embodiment. The ZTS function 31 transmits the authenticity certificate and the signature by the ZTS function 31 to the authentication cooperation proxy control unit 32. Here, the ZTS function 31 may transmit the confirmation result of the authenticity to the authentication cooperation proxy control unit 32. The ZTS function 31 may transmit the public key for verifying the signature to the authenticity verification server 40 via the communication unit 34. The public key may be issued by the TPM. The ZTS function 31 may transmit the content of the authenticity certificate to the authenticity verification server 40.

The authentication cooperation proxy control unit 32 issues an instruction to the terminal proxy function 33 to replace the digital certificate received at the time of communication by the application of the terminal apparatus 20 with the authenticity certificate. The authentication cooperation proxy control unit 32 receives the authenticity certificate of the terminal-side communication apparatus 30 from the ZTS function 31 to determine whether to issue the instruction to perform the replacement. The authentication cooperation proxy control unit 32 may determine whether to issue the instruction to perform the replacement by receiving the confirmation result of the authenticity from the ZTS function 31. The authentication cooperation proxy control unit 32 corresponds to a control function of the replacement unit 4 of the terminal apparatus 2 according to the first example embodiment. The authentication cooperation proxy control unit 32 transmits the authenticity certificate to the terminal proxy function 33.

The authentication cooperation proxy control unit 32 may issue an instruction to necessarily replace the digital certificate with the authenticity certificate in a case where the authenticity of the terminal-side communication apparatus 30 can be confirmed, or may not issue an instruction to replace the digital certificate with the authenticity certificate even in a case where the authenticity can be confirmed. The authentication cooperation proxy control unit 32 may issue the instruction to replace the digital certificate with the authenticity certificate only in a case where the authenticity of the terminal-side communication apparatus 30 can be confirmed and the server 60 is a server determined in advance. That is, in a case where the server 60 is not the server determined in advance, even in a case where the authenticity of the terminal-side communication apparatus 30 can be confirmed, the authentication cooperation proxy control unit 32 may not issue the instruction to perform replacement with the authenticity certificate.

The terminal proxy function 33 has a function as a proxy for the communication by the application of the terminal apparatus 20. That is, the terminal proxy function 33 has a function of relaying the data communication by the application of the terminal apparatus 20. The terminal proxy function 33 can receive the digital certificate and the public key issued by the terminal apparatus 20 from the terminal apparatus 20 via the communication unit 34. The terminal proxy function 33 may compare a hash value obtained by decrypting the signature by the CA with a hash value obtained by hashing the digital certificate to verify the validity of the digital certificate.

The terminal proxy function 33 may transmit a public key for encrypting the communication data by the application of the terminal apparatus 20 to the terminal apparatus 20 via the communication unit 34. In this case, the terminal proxy function 33 may transmit the digital certificate together with the public key. The digital certificate may be signed by the CA or may be signed by the terminal proxy function 33. The digital certificate in this case is also referred to as a server certificate.

The terminal proxy function 33 may receive a public key for encrypting the communication data from the server-side communication apparatus 50 via the communication unit 34 in the data communication by the application of the terminal apparatus 20. In this case, the terminal proxy function 33 may decrypt the communication data received from the terminal apparatus 20 with a secret key generated by the TPM of the terminal apparatus 20, and may encrypt the communication data with the public key received from the server-side communication apparatus 50.

Based on the instruction from the authentication cooperation proxy control unit 32, the terminal proxy function 33 replaces the received digital certificate with the authenticity certificate. The terminal proxy function 33 receives the authenticity certificate and the signature attached by the ZTS function 31 from the authentication cooperation proxy control unit 32. The terminal proxy function 33 replaces the digital certificate with the authenticity certificate, and transmits the authenticity certificate and the signature attached by the ZTS function 31 to the server-side communication apparatus 50. In a case where the digital certificate is not replaced with the authenticity certificate, the terminal proxy function 33 may transmit the digital certificate and the signature attached by the CA to the server-side communication apparatus 50.

The terminal proxy function 33 may decrypt the signature attached to the digital certificate with a public key of the CA, rewrite the content to that of the authenticity certificate, and attach the signature by the ZTS function 31 to replace the digital certificate with the authenticity certificate. The terminal proxy function 33 may delete the digital certificate and the signature by the CA, and use the authenticity certificate and the signature by the ZTS function 31 as new transmission data to perform the replacement. That is, the authentication cooperation proxy control unit 32 has a replacement function of the replacement unit 4 of the terminal apparatus 2 according to the first example embodiment.

The communication unit 34 can transmit and receive predetermined data to and from the terminal apparatus 20, the authenticity verification server 40, and the server-side communication apparatus 50. The communication unit 34 is a component corresponding to the transmission unit 5 of the terminal apparatus 2 according to the first example embodiment.

The authenticity verification server 40 is a server for confirming the authenticity of the terminal-side communication apparatus 30. That is, the authenticity verification server 40 corresponds to another server in a case where the authenticity is confirmed by the another server other than the terminal apparatus 2 in the first example embodiment. The authenticity verification server 40 may be a server under the control of the server-side communication apparatus 50, or may be the same server as the server-side communication apparatus 50. The authenticity verification server 40 includes a confirmation unit 41, a notification unit 42, and a transmission unit 43.

The confirmation unit 41 confirms the authenticity of the terminal-side communication apparatus 30. The confirmation unit 41 may be able to confirm the authenticity of the terminal-side communication apparatus 30 by remote attestation. The remote attestation is a method of confirming the authenticity of the terminal-side communication apparatus 30 by comparing information regarding the hardware configuration and software stored in the TPM of the terminal-side communication apparatus 30 with information included in the confirmation unit 41. Here, the information included in the confirmation unit 41 is the same information as that of the TPM of the terminal-side communication apparatus 30, and is information at the time of factory shipment on the terminal-side communication apparatus 30. That is, at the time of confirmation of the authenticity, the confirmation unit 41 receives the information regarding the hardware configuration and software stored in the TPM from the terminal-side communication apparatus 30.

In a case where the confirmation unit 41 has confirmed the authenticity, the notification unit 42 transmits information for verifying the authenticity certificate to the server-side communication apparatus 50. The information for verifying the authenticity certificate may be, for example, a verification key. Specifically, the information may be a public key associated to the secret key used at the time of signing the authenticity certificate by the ZTS function 31. That is, the information may be the public key issued by the TPM of the terminal-side communication apparatus 30. The information may be the content of the authenticity certificate.

The transmission unit 43 transmits the confirmation result of the authenticity by the confirmation unit 41 to the terminal-side communication apparatus 30. That is, in a case where the confirmation unit 41 has confirmed the authenticity, the transmission unit 43 may transmit information indicating the fact to the terminal-side communication apparatus 30. In a case where the confirmation unit 41 is not able to confirm the authenticity, the transmission unit 43 may transmit information indicating the fact to the terminal-side communication apparatus 30.

The server-side communication apparatus 50 is a communication infrastructure that relays application data transmitted and received by the server 60. That is, the server-side communication apparatus 50 is a reverse proxy. The server-side communication apparatus 50 corresponds to the verification apparatus 3 according to the first example embodiment. The server-side communication apparatus 50 may be a host server of the authenticity verification server 40, or may be the same server as the authenticity verification server 40. In a case where the terminal apparatus 20 and the terminal-side communication apparatus 30 are apparatuses mounted on a mobile body, the server-side communication apparatus 50 may be an apparatus disposed on the ground. The server-side communication apparatus 50 includes an authentication cooperation proxy verification unit 51, a reverse proxy function 52, and a communication unit 53.

The authentication cooperation proxy verification unit 51 verifies the authenticity certificate received from the terminal proxy function 33 via the communication unit 53. During the verification, the authentication cooperation proxy verification unit 51 uses the information for verifying the authenticity certificate, the information being received from the notification unit 42 via the communication unit 53. The authentication cooperation proxy verification unit 51 may perform verification of the authenticity certificate by comparing the authenticity certificate and the hash value of the signature with each other by using a public key received from the notification unit 42, for example. The public key may be generated by the ZTS function 31. The authentication cooperation proxy verification unit 51 may perform the verification of the authenticity certificate by collating the content of the authenticity certificate received from the notification unit 42 with the content of the authenticity certificate received from the terminal proxy function 33.

The authentication cooperation proxy verification unit 51 may permit the communication by the application of the terminal apparatus 20 only in a case where a verification result of the authenticity certificate is correct. That is, in a case where the communication unit 53 receives the digital certificate instead of the authenticity certificate, the authentication cooperation proxy verification unit 51 may not permit the communication by the application of the terminal apparatus 20. Even in a case where the reverse proxy function 52 receives the digital certificate, the authentication cooperation proxy verification unit 51 may permit the communication by the application by the terminal apparatus 20 as long as the validity of the digital certificate can be confirmed.

The reverse proxy function 52 has a function as a proxy for data communication by the server 60. That is, the reverse proxy function 52 has a function of relaying the data communication by the server 60. In a case where the communication unit 53 receives the authenticity certificate and the authentication cooperation proxy verification unit 51 permits the communication by the application of the terminal apparatus 20, the reverse proxy function 52 permits the communication. In this case, the reverse proxy function 52 may replace the received authenticity certificate with the digital certificate. Specifically, the reverse proxy function 52 may request the CA to issue a signed digital certificate, and replace the authenticity certificate with the digital certificate received from the CA. Here, a method of replacement with the digital certificate may be a method similar to a method of replacing the digital certificate with the authenticity certificate by the terminal proxy function 33. The reverse proxy function 52 may simply delete the authenticity certificate. That is, the reverse proxy function 52 may not transmit the certificate to the server 60.

In a case where the communication unit 53 receives the digital certificate and the authentication cooperation proxy verification unit 51 permits the communication by the application of the terminal apparatus 20, the reverse proxy function 52 may transmit the digital certificate to the server 60 as it is.

The reverse proxy function 52 may transmit a public key for encrypting the communication data by the application of the terminal apparatus 20 to the terminal-side communication apparatus 30 via the communication unit 53. In this case, the reverse proxy function 52 may transmit the digital certificate together with the public key. The digital certificate may be signed by the CA or may be signed by the reverse proxy function 52. The digital certificate is also referred to as a server certificate.

The reverse proxy function 52 may receive a public key for encrypting the communication data from the server 60 via the communication unit 53 in the data communication by the application of the terminal apparatus 20. In this case, the reverse proxy function 52 may decrypt the communication data received from the terminal-side communication apparatus 30 with the secret key generated by the reverse proxy function 52 and encrypt the communication data with the public key received from the server 60.

The reverse proxy function 52 may not receive the public key for encrypting the communication data by the application of the terminal apparatus 20 from the server 60 via the communication unit 53. In this case, the reverse proxy function 52 may decrypt the communication data received from the terminal-side communication apparatus 30 with the secret key generated by the reverse proxy function 52 and transmit the communication data to the server 60 in plaintext.

The communication unit 53 can transmit and receive predetermined data to and from the terminal-side communication apparatus 30, the authenticity verification server 40, and the server 60. The communication unit 53 is a component corresponding to the receiving unit 6 according to the first example embodiment.

The server 60 is a server that is the other party with which the application of the terminal apparatus 20 communicates. The server 60 may be an application server or a web server. The server 60 may transmit a public key for encrypting the communication data by the application of the terminal apparatus 20 to the server-side communication apparatus 50. In this case, the server 60 may transmit the digital certificate together with the public key. The digital certificate may be signed by the CA. That is, the server 60 may transmit the server certificate to the server-side communication apparatus 50.

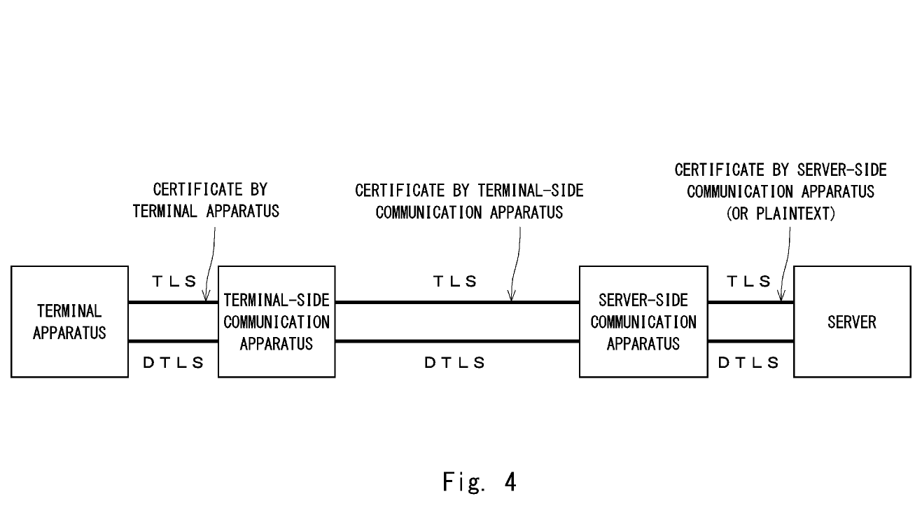

Next, a specific example of the communication control system 10 will be described. FIG. 4 is a schematic diagram illustrating a specific example of the communication control system 10. The authenticity verification server 40 is omitted in FIG. 4. In FIG. 4, it is assumed that the terminal apparatus 20, the terminal-side communication apparatus 30, the server-side communication apparatus 50, and the server 60 perform communication based on TLS and DTLS security protocols. Communication is performed between the terminal apparatus 20 and the terminal-side communication apparatus 30 with a certificate that the terminal apparatus 20 requests the CA to issue, that is, a digital certificate. On the other hand, between the terminal-side communication apparatus 30 and the server-side communication apparatus 50, communication is performed with an authenticity certificate issued by the ZTS function 31 of the terminal-side communication apparatus 30. Then, between the server-side communication apparatus 50 and the server 60, communication is performed with a digital certificate that the server-side communication apparatus 50 requests the CA to issue. Here, the server-side communication apparatus 50 may transmit data decrypted with a secret key of the server-side communication apparatus 50 to the server 60 as it is without requesting issuance of a digital certificate.

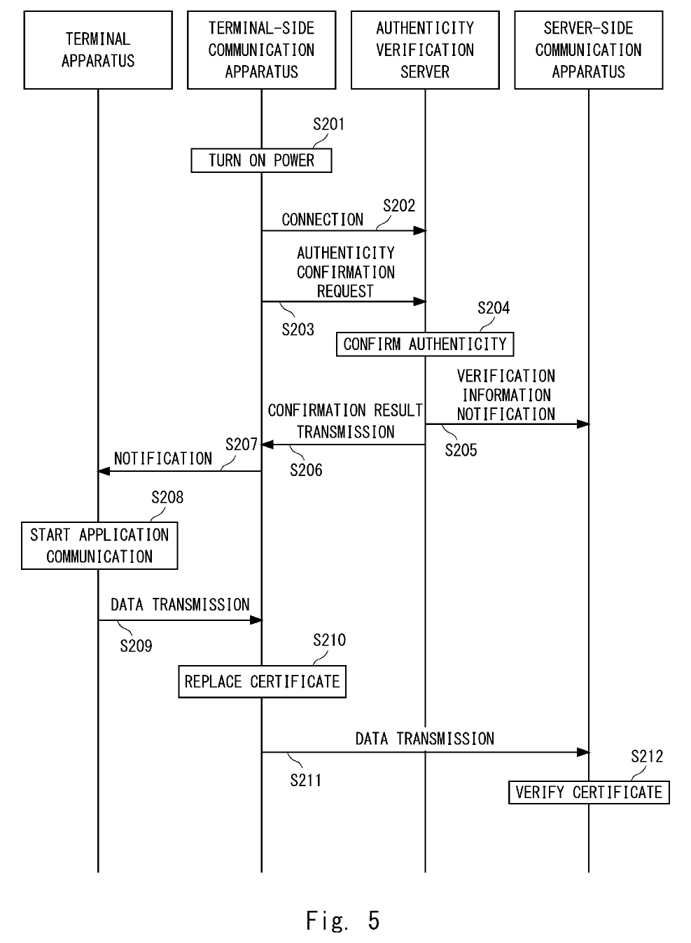

Next, a flow of a processing operation by the communication control system 10 will be described. FIG. 5 is a sequence diagram illustrating an example of a processing operation of the communication control system 10. First, at the time of the communication by the application of the terminal apparatus 20, the terminal-side communication apparatus 30 enters a state in which power is turned on (S201). The terminal-side communication apparatus 30 connects to the authenticity verification server 40 (S202). Next, the terminal-side communication apparatus 30 requests that the authenticity verification server 40 confirms the authenticity of the terminal-side communication apparatus 30 (S203). In other words, the terminal-side communication apparatus 30 requests the authenticity verification server 40 to confirm the authenticity of the terminal-side communication apparatus 30.

Thereafter, the authenticity verification server 40 confirms the authenticity of the terminal-side communication apparatus 30 (S204). In a case where the authenticity of the terminal-side communication apparatus 30 has been confirmed, the authenticity verification server 40 communicates the information for verifying the authenticity certificate to the server-side communication apparatus 50 (S205). Thereafter, the authenticity verification server 40 transmits a confirmation result of the authenticity to the terminal-side communication apparatus 30 (S206). Here, the authenticity verification server 40 may not perform step S205 at this stage. The authenticity verification server 40 may simultaneously perform step S205 and step S206, or may perform step S206 before step S205.

Thereafter, the terminal-side communication apparatus 30 notifies the terminal apparatus 20 of the fact that confirmation of the authenticity has ended (S207). Here, the terminal-side communication apparatus 30 may transmit a public key for encrypting communication data to the terminal apparatus 20. Thereafter, the terminal apparatus 20 starts the communication by the application (S208). The terminal apparatus 20 transmits the communication data to the terminal-side communication apparatus 30 (S209). Here, the terminal apparatus 20 may transmit only the digital certificate to the terminal-side communication apparatus 30, or may transmit encrypted communication data together with the digital certificate. Thereafter, the terminal-side communication apparatus 30 replaces the digital certificate with the authenticity certificate (S210).

Thereafter, the terminal-side communication apparatus 30 transmits the communication data to the server-side communication apparatus 50 (S211). Here, the terminal-side communication apparatus 30 may transmit only the authenticity certificate to the server-side communication apparatus 50, or may transmit only the digital certificate to the server-side communication apparatus 50. The terminal-side communication apparatus 30 may transmit the encrypted communication data together with any of the certificates. Thereafter, the server-side communication apparatus 50 verifies the received authenticity certificate (S212). The authenticity verification server 40 may notify the server-side communication apparatus 50 of verification information regarding step S205 at a timing at which the server-side communication apparatus 50 verifies the authenticity certificate.

As described above, the communication control system 10 according to the present second example embodiment includes the authenticity verification server 40, and the authenticity verification server 40 includes the confirmation unit 41 that confirms the authenticity of the terminal-side communication apparatus 30, so that it is possible to reliably perform the verification of the authenticity certificate in the server-side communication apparatus 50. The authenticity verification server 40 includes the notification unit 42 that transmits the information for verifying the authenticity certificate to the server-side communication apparatus 50, so that the server-side communication apparatus 50 can perform the verification of the authenticity certificate, based on the verification information at the time of authenticity confirmation. The authenticity verification server 40 includes the transmission unit 43 that transmits the confirmation result of the authenticity to the terminal-side communication apparatus 30, so that the terminal-side communication apparatus 30 can determine whether to issue the authenticity certificate, based on the confirmation result.

The server-side communication apparatus 50 of the communication control system 10 corresponds to the verification apparatus 3 of the communication control system 1 according to the first example embodiment. The server-side communication apparatus 50 is a reverse proxy. On the receiving side of the system, the server-side communication apparatus 50 that is a reverse proxy determines whether to permit the communication by the application, so that the server-side communication apparatus 50 can relay communication to the server 60. For that reason, the system configuration of the communication control system 10 can be simplified.

The authenticity is verified by a communication apparatus including a proxy function, such as the terminal-side communication apparatus 30 and the server-side communication apparatus 50, so that it is possible to implement zero trust security without changing the application program. That is, the communication control system 10 can avoid application-dependent vulnerability.

The communication control system 10 is effective at the time of performing communication with a server on the ground by an application installed on Internet of Things (IoT) equipment such as an aircraft, an automobile, or a ship. That is, in the IoT equipment as described above, the manufacturer of the communication infrastructure may be different from that of the introduced application. In such a case, it is difficult to implement zero trust security by confirming the authenticity of the communication infrastructure by any server, and performing authentication cooperation on an application side that is not the manufacturer of the communication infrastructure. According to the communication control system 10, since the confirmation of the authenticity of the communication infrastructure and the verification of the authenticity certificate can be completed between the proxies that are the communication infrastructures, it is possible to implement zero trust security without changing the application program installed on the IoT equipment.

### Hardware Configuration Example

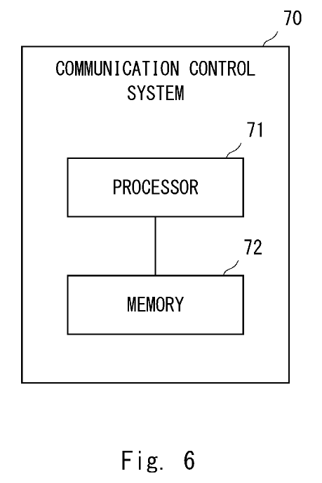

FIG. 6 is a diagram illustrating a hardware configuration example of a communication control system 70 according to the present disclosure. In FIG. 6, the communication control system 70 includes a processor 71 and a memory 72. The processor 71 may be, for example, a microprocessor, an MPU, or a CPU. The processor 71 may include a plurality of processors. The memory 72 includes a combination of a volatile memory and a nonvolatile memory. The memory 72 may include a storage disposed away from the processor 71. In this case, the processor 71 may access the memory 72 via an Input/Output (I/O) interface, which is not illustrated.

In the above-described example, a program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line. The computer includes various information processing apparatuses such as a PC, a server, a CPU, an MPU, a Field Programmable Gate Array (FPGA), and an Application Specific Integrated Circuit (ASIC).

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example for describing one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated or described. All of the features or the steps illustrated in any one of the drawings for describing illustrative example embodiments are not necessarily mandatory, and some features or steps may be omitted. The order of the steps described in any of the figures may be changed as appropriate.

Some or all of the above example embodiments can also be described as the following Supplementary Notes, but are not limited to the following.

### Supplementary Note 1

A communication control system including

a terminal apparatus including a replacement unit that replaces, in a case where a predetermined digital certificate has been issued at time of communication by an application of the terminal apparatus and authenticity of a communication infrastructure of the terminal apparatus has been confirmed, the digital certificate with an authenticity certificate certifying the authenticity, and a transmission unit that transmits the authenticity certificate to a predetermined server, and

a verification apparatus including a receiving unit that receives the authenticity certificate from the terminal apparatus, and a verification unit that verifies the authenticity certificate to determine whether to permit the communication by the application to the server.

### Supplementary Note 2

The communication control system according to Supplementary Note 1, further including an authenticity verification server including

a confirmation unit that confirms the authenticity of the communication infrastructure of the terminal apparatus, and

a notification unit that notifies the verification apparatus of information for verifying the authenticity certificate in a case where the confirmation unit has confirmed the authenticity.

### Supplementary Note 3

The communication control system according to Supplementary Note 1 or 2, in which the verification unit of the verification apparatus permits the communication by the application only in a case where a verification result of the authenticity certificate is correct.

### Supplementary Note 4

The communication control system according to any one of Supplementary Notes 1 to 3, in which the transmission unit of the terminal apparatus transmits the authenticity certificate to the server in a case where the authenticity has been confirmed, and transmits the digital certificate to the server in a case where the authenticity is not confirmed.

### Supplementary Note 5

The communication control system according to any one of Supplementary Notes 1 to 4, in which the replacement unit of the terminal apparatus replaces the digital certificate with the authenticity certificate in a case where the server is a server determined in advance.

### Supplementary Note 6

The communication control system according to any one of Supplementary Notes 1 to 5, in which the verification apparatus is a proxy server.

### Supplementary Note 7

The communication control system according to any one of Supplementary Notes 2 to 6, in which the authenticity verification server further includes a transmission unit that transmits a confirmation result of the authenticity to the terminal apparatus.

### Supplementary Note 8

A communication control method in which one or more computers

replace, in a case where a predetermined digital certificate has been issued at time of communication by an application of the terminal apparatus and authenticity of a communication infrastructure of the terminal apparatus has been confirmed, the digital certificate with an authenticity certificate certifying the authenticity,

transmit the authenticity certificate to a predetermined server, receive the authenticity certificate from the terminal apparatus, verify the authenticity certificate, and determine whether to permit the communication by the application to the server.

### Supplementary Note 9

A program for causing a computer to execute

a step of replacing, in a case where a predetermined digital certificate has been issued at time of communication by an application of the terminal apparatus and authenticity of a communication infrastructure of the terminal apparatus has been confirmed, the digital certificate with an authenticity certificate certifying the authenticity,

a step of transmitting the authenticity certificate to a predetermined server,

a step of receiving the authenticity certificate from the terminal apparatus,

a step of verifying the authenticity certificate, and

a step of determining whether to permit the communication by the application to the server.

### Supplementary Note 10

A terminal apparatus including

a replacement unit that replaces, in a case where a predetermined digital certificate has been issued at time of communication by an application of the terminal apparatus and authenticity of a communication infrastructure of the terminal apparatus has been confirmed, the digital certificate with an authenticity certificate certifying the authenticity, and

a transmission unit that transmits the authenticity certificate to a predetermined server.

### Supplementary Note 11

The terminal apparatus according to Supplementary Note 10, in which the transmission unit transmits the authenticity certificate to the server in a case where the authenticity has been confirmed, and transmits the digital certificate to the server in a case where the authenticity is not confirmed.

### Supplementary Note 12

The terminal apparatus according to Supplementary Note 10 or 11, in which the replacement unit replaces the digital certificate with the authenticity certificate in a case where the server is a server determined in advance.

### Supplementary Note 13

A communication control method in which a computer

replaces, in a case where a predetermined digital certificate has been issued at time of communication by an application of the terminal apparatus and authenticity of a communication infrastructure of the terminal apparatus has been confirmed, the digital certificate with an authenticity certificate certifying the authenticity, and

transmits the authenticity certificate to a predetermined server.

### Supplementary Note 14

A program for causing a computer to execute

a step of replacing, in a case where a predetermined digital certificate has been issued at time of communication by an application of the terminal apparatus and authenticity of a communication infrastructure of the terminal apparatus has been confirmed, the digital certificate with an authenticity certificate certifying the authenticity, and

a step of transmitting the authenticity certificate to a predetermined server.

### Supplementary Note 15

A verification apparatus including

a receiving unit that receives, in a case where authenticity of a communication infrastructure of a terminal apparatus has been confirmed, an authenticity certificate certifying the authenticity from the terminal apparatus, the authenticity certificate replacing a predetermined digital certificate issued at time of performing communication by an application to a predetermined server, and

a verification unit that verifies the authenticity certificate to determine whether to permit the communication by the application to the server.

### Supplementary Note 16

The verification apparatus according to Supplementary Note 15, in which the verification unit permits the communication by the application only in a case where a verification result of the authenticity certificate is correct.

### Supplementary Note 17

The verification apparatus according to Supplementary Note 15 or 16, in which the verification apparatus is a proxy server.

### Supplementary Note 18

A communication control method in which a computer

receives, in a case where authenticity of a communication infrastructure of a terminal apparatus has been confirmed, an authenticity certificate certifying the authenticity from the terminal apparatus, the authenticity certificate replacing a predetermined digital certificate issued at time of performing communication by an application to a predetermined server,

verifies the authenticity certificate, and determines whether to permit the communication by the application to the server.

### Supplementary Note 19

A program for causing a computer to execute

a step of receiving, in a case where authenticity of a communication infrastructure of a terminal apparatus has been confirmed, an authenticity certificate certifying the authenticity from the terminal apparatus, the authenticity certificate replacing a predetermined digital certificate issued at time of performing communication by an application to a predetermined server,

a step of verifying the authenticity certificate, and

a step of determining whether to permit the communication by the application to the server.

### Supplementary Note 20

An authenticity verification server including

a confirmation unit that confirms authenticity of a communication infrastructure of a terminal apparatus that performs communication by an application to a predetermined server, and

a notification unit that transmits information for verifying an authenticity certificate certifying the authenticity to a verification apparatus in a case where the confirmation unit has confirmed the authenticity.

### Supplementary Note 21

The authenticity verification server according to Supplementary Note 20, further including a transmission unit that transmits a confirmation result of the authenticity to the terminal apparatus.

### Supplementary Note 22

A communication control method in which a computer

confirms authenticity of a communication infrastructure of a terminal apparatus that performs communication by an application to a predetermined server, and

transmits information for verifying an authenticity certificate certifying the authenticity to a verification apparatus in a case where the authenticity has been confirmed.

### Supplementary Note 23

A program for causing a computer to execute

a step of confirming authenticity of a communication infrastructure of a terminal apparatus that performs communication by an application to a predetermined server, and

a step of transmitting information for verifying an authenticity certificate certifying the authenticity to a verification apparatus in a case where the authenticity has been confirmed.

Some or all of the elements (for example, configurations and functions) described in Supplementary Notes 2 to 7 subordinate to Supplementary Note 1 can also be subordinate to Supplementary Notes 8 and 9 by the subordinate relationship similar to that with Supplementary Notes 2 to 7. Some or all of the elements described in Supplementary Notes 11 to 12 subordinate to Supplementary Note 10 can also be subordinate to Supplementary Notes 13 and 14 by the subordinate relationship similar to that with Supplementary Notes 11 to 12. Some or all of the elements described in Supplementary Notes 16 to 17 subordinate to Supplementary Note 15 can also be subordinate to Supplementary Notes 18 and 19 by the subordinate relationship similar to that with Supplementary Notes 16 to 17. Some or all of the elements described in Supplementary Note 21 subordinate to Supplementary Note 20 can also be subordinate to Supplementary Notes 22 and 23 by the subordinate relationship similar to that with Supplementary Note 21. Some or all of the elements described in any Supplementary Note may be applied to various types of hardware, software, recording means for recording software, systems, and methods.

1. A communication control system comprising:
a terminal apparatus comprising:
at least one memory storing instructions, and
at least one processor configured to execute the instructions to;
replace, in a case where a predetermined digital certificate has been issued at time of communication by an application of the terminal apparatus and authenticity of a communication infrastructure of the terminal apparatus has been confirmed, the digital certificate with an authenticity certificate certifying the authenticity; and transmit the authenticity certificate to a predetermined server; and
a verification apparatus comprising:
at least one memory storing instructions, and
at least one processor configured to execute the instructions to;
receive the authenticity certificate from the terminal apparatus; and verify the authenticity certificate to determine whether to permit the communication by the application to the server.

2. The communication control system according to claim 1, further comprising an authenticity verification server which comprises:
at least one memory storing instructions, and
at least one processor configured to execute the instructions to;
confirm the authenticity of the communication infrastructure of the terminal apparatus; and
notify the verification apparatus of information for verifying the authenticity certificate in a case where the authenticity verification server has confirmed the authenticity.

3. The communication control system according to claim 1, wherein the at least one processor of the verification apparatus is further configured to execute the instructions to permit the communication by the application only in a case where a verification result of the authenticity certificate is correct.

4. The communication control system according to claim 1, wherein the at least one processor of the terminal apparatus is further configured to execute the instructions to transmit the authenticity certificate to the server in a case where the authenticity has been confirmed, and transmit the digital certificate to the server in a case where the authenticity is not confirmed.

5. The communication control system according to claim 1, wherein the at least one processor of the terminal apparatus is further configured to execute the instructions to replace the digital certificate with the authenticity certificate in a case where the server is a server determined in advance.

6. The communication control system according to claim 1, wherein the verification apparatus is a proxy server.

7. The communication control system according to claim 2, wherein the at least one processor of the authenticity verification server is further configured to execute the instructions to transmit a confirmation result of the authenticity to the terminal apparatus.

8. A communication control method wherein
one or more computers
replace, in a case where a predetermined digital certificate has been issued at time of communication by an application of the terminal apparatus and authenticity of a communication infrastructure of the terminal apparatus has been confirmed, the digital certificate with an authenticity certificate certifying the authenticity,
transmit the authenticity certificate to a predetermined server,
receive the authenticity certificate from the terminal apparatus,
verify the authenticity certificate, and
determine whether to permit the communication by the application to the server.

9. A terminal apparatus comprising:
at least one memory storing instructions, and
at least one processor configured to execute the instructions to;
replace, in a case where a predetermined digital certificate has been issued at time of communication by an application of the terminal apparatus and authenticity of a communication infrastructure of the terminal apparatus has been confirmed, the digital certificate with an authenticity certificate certifying the authenticity; and
transmit the authenticity certificate to a predetermined server.

10. The terminal apparatus according to claim 9, wherein the at least one processor is further configured to execute the instructions to transmit the authenticity certificate to the server in a case where the authenticity has been confirmed, and transmit the digital certificate to the server in a case where the authenticity is not confirmed.

11. The terminal apparatus according to claim 9, wherein the at least one processor is further configured to execute the instructions to replace the digital certificate with the authenticity certificate in a case where the server is a server determined in advance.
